(19) United States
(12) Patent Application Publication
(10) Pub. No.: US 2008/0139700 A1
(43) Pub. Date: Jun. 12, 2008

(54) Methods for devolatilizing resin solutions and resins produced thereby

(76) Inventors: Don R. Roden, Williamsburg, MI (US); Paul J. Prucnal, Pittsburgh, PA (US); Szuping Lu, Canton, MI (US)

Correspondence Address: BUCHANAN, INGERSOLL & ROONEY PC, POST OFFICE BOX 1404, ALEXANDRIA, VA, 22313-1404, US

(21) Appl. No.: 11/636,431

(22) Filed: Dec. 11, 2006

(51) Int. Cl. C08J 3/00; C08F 6/00

(52) U.S. Cl. 523/340; 528/502 C

(57) ABSTRACT

A method of continuously devolatilizing a liquefied material utilizing an extruder having a barrel in which is disposed a plurality of continuously driven intermeshing conveying screws that continuously advance a flow of the liquefied material from an extruder inlet to an extruder outlet. The material contains 10-60 percent gaseous volatiles. Heat is introduced from an external source into the flow of liquefied material to progressively increase the temperature of the liquefied material being advanced, for promoting the separation of volatiles therefrom. Separated gaseous volatiles are vented through vapor escape ports formed in the extruder barrel, with the linear vapor velocity of the escaping volatiles not exceeding about 10-15 f/sec to avoid the venting of appreciable amounts of liquefied material along with the gaseous volatiles.

### BACKGROUND OF THE INVENTION

The invention relates to a method for the removal of volatile organic solvents and volatile reactants from certain resins. The invention also relates to devolatilized resins having low levels of low molecular weight materials.

In order to develop environmentally friendly coatings and other products, it is often necessary to remove volatile organic solvents and volatile reactants from the resins (polymers) that will be used to prepare, for example, powder coatings or other products that are free of volatile organic compounds. The volatiles (e.g. solvent) may be necessary to synthesize the resin or polymer or may be a residual reactant in the process.

A common method for devolatilizing such resins (polymers) involves a batch process in which the resin solution or molten resin containing residual volatiles is stirred in a vessel with a large headspace while applying heat and vacuum until volatiles are reduced to the desired level. For semi-works or large scale production, the prolonged times at elevated temperature often produce undesirable effects such as poor color, reduced functionality, decomposition of the resin or gellation (premature crosslinking) of the resin. Thus several types of functional resins and specific heat sensitive compositions cannot be successfully devolatilized in a batch process.

In the case of acrylic polymers, the decomposition that occurs at temperatures above about 150° C. is such that the desired low level of volatiles is difficult to reach due to the volatiles produced from decomposition or unzipping of the acrylic chain. Besides the volatility of residual monomers, their presence is often undesirable from the standpoint of objectionable odor they confer to the produce or because they may be skin sensitizers or have other undesirable physiological effects. Also, oligomeric species often result from secondary reactions of the volatile monomers, which are deleterious because of a lack of functionality or by introducing color, either directly, or by interaction with additives in final formulations. Batch to batch inconsistency also provides a substantial challenge in obtaining a uniform product as the low molecular weight materials function as plasticizers. One way of addressing the challenge of volatiles in acrylic resins is set forth in U.S. Pat. No. 6,670,411, the contents of which are incorporated by reference. As disclosed therein, a defined hindered amine light stabilizer is added to the acrylic resin to inhibit depolymerization of the polymer chain during devolatilization.

In the case of urethane resins used for coatings or elastomer applications, it is desirable to remove the residual monomeric diisocyanates that can create environmental concerns for plant workers, formulators or the end users. It is extremely difficult to remove such monomeric diisocyanates in a batch devolatilization process because the prolonged times at sufficiently high temperatures can result in decomposition of the polyurethanes. Other methods, such as wiped film evaporators, suffer from disadvantages such as low output and inability to handle high viscosity resins.

There is increasing interest in producing solid resins for UV curable powder coatings. Since most such resins must be produced in solution, devolatilization without gellation of these thermally unstable resins is a challenge. Examples of resins in this class are (meth)acrylate functional acrylics and (meth)acrylate functional urethanes (urethane (meth)acrylate resins). Even relatively short exposures at temperatures above 90° C. in the absence of stabilizers cause such resins to advance in molecular weight or to crosslink (gel) to intractable solids. Even with stabilizers, stability at such temperatures is limited.

Isobornylacrylate (IBOA) and isobornylmethacrylate (IBOMA) are highly desirable monomers to include in the design of all types of acrylic resins for powder coatings. Either monomer may be used to increase the glass transition temperature (Tg) of solid resins made for powder coatings. This is particularly useful for the synthesis of resins with low molecular weight to maximize flow and leveling in the early stages of powder coating cure. Suitable levels of IBOA or IBOMA can maintain the physical stability (i.e. resistance to sintering) of the powder coating and may confer other desirable properties to the final cured coating because of a degree of hydrophobicity either can impart to the resin.

Acrylic resins prepared with IBOA or IBOMA typically have a higher level of residual monomers than other resins, depending on specific co-monomers used, due to lower conversions. Moreover, residual volatile levels increase markedly after batch devolatilizations which also include unidentified decomposition products. Such resins also have a marked terpene-like odor.

Another monomer that would be desirable for the preparation of powder coating resins is tertiary butyl acrylate (TBA) or methacrylate (TBMA) which also increase the Tg of acrylic resins and may contribute unique properties to the resin. Resins made with these monomers are also thermally unstable and decompose during batch devolatilization operations.

Continuous devolatilization mechanisms have been heretofore proposed, such as multi-screw extruders (e.g., see U.S. Published Patent Application Serial No. 2005/0105382, and U.S. Pat. No. 5,836,682.) It is conventional in such extruders for continuously driven intermeshing conveying screws to advance the material to be devolatilized, in liquefied form, within a space or core. A cross sectional view through a prior art extruder (i.e., a ring extruder) disclosed in Published U.S. Serial No. 2005/0105382 is depicted in the accompanying FIG. 1 in which twelve conveying screws 2 are shown as arranged in an annularly-shaped space 4 in an extruder barrel 6.

An inherent characteristic of the ring extruder is the elimination of foaming as a limiting factor for the rate of devolatilization. This is a result of the mechanical action of the extruder elements in the suppression (destruction) of foam as the feedstock is mechanically forced through and among the extruder elements.

Multiple screw extruders have generally been used to process mixtures that are substantially non-volatile. In cases where one or more components of a mixture contains a volatile component(s), or, in the case of extrusion of a reactive mixture which generates a volatile by-product, such as water or an alcohol, the proportion of the volatile component(s) is usually very low, i.e. on the order of 1-3% of the total mixture. In such cases it is usually desirable to remove the volatiles before the product is discharged and this is accomplished by boring small diameter holes along or near the end of the extruder barrel through which the volatiles may be vented or conducted to a suitable collection vessel at either atmosphere or at reduced pressure. This arrangement may even be workable with mixtures containing up to 5% volatiles, as long as the melt viscosity of the mixture being extruded is substantially higher than that of the volatiles being removed. This condition allows the volatiles to easily escape without entrainment of the non-volatile components.

One object of the present invention is to utilize the superior surface area generating characteristics of multiple screw extruders to advantage in removing volatiles from resin solutions especially solutions containing 10 to 60 percent volatiles. Such solutions have greatly reduced viscosities, especially at the elevated temperatures necessary for efficient volatilization of the volatile components. This cannot be accomplished using the above conventional multi-screw method, since the escaping volatiles will carry (entrain) significant quantities of the non-volatile component(s), which cannot be accommodated by the conventional apparatus/method, preventing the separation of the two. The volume of escaping solvent is so great that an extruder of impractical length would be required before the exiting product would be substantially free of volatiles.

Therefore it would be desirable to provide continuous devolatilization methods which are capable of maximizing the volume of volatiles separated from certain resins being processed, while preventing the escape of an appreciable amount of liquefied resin material with the volatiles.

It would also be desirable to provide devolatilization methods which minimize the time at which certain resin solutions are exposed to elevated temperatures.

It would further be desirable to provide methods for continuous devolatilization which minimize the temperatures to which certain resin solutions are exposed.

### SUMMARY OF PREFERRED EMBODIMENTS

As described hereafter, methods and apparatus for the continuous devolatilization of resins have been developed which are capable of removing exceptionally large volumes of volatiles from both thermally stable and thermally unstable resins. Moreover, that is achieved, even in the case of thermally unstable resins, without producing degradation or gellation of the resins. In particular, a unique combination of method steps function to advance the liquefied resin, while spreading the liquefied resin into an extremely large surface area, thereby maximizing the rate of evaporation. Moreover, the removal of the separated gaseous volatiles is effected through respective gas outlet ports without the loss of an appreciable amount of the molten polymer along with the gaseous volatiles being removed. That is accomplished by providing vapor escape ports that are large enough to cause the velocity of the gaseous volatiles passing therethrough not to exceed a value of 10-15 f/sec, preferably not to exceed about 5.5 f/sec.

A method of continuously devolatilizing a liquefied material utilizes an extruder which comprises a barrel defining an interior space in which is disposed a plurality of intermeshing conveying screws for advancing a flow of the liquefied material within the interior space from an extruder inlet to an extruder outlet. The method comprises the steps of:

(A) providing, as the liquefied material to be devolatilized, a mixture of resin selected from the group consisting of acrylic resins and urethane (meth)acrylate resins and a solvent for the resins;

(B) continuously advancing the flow of material from the extruder inlet to the extruder outlet by the conveying screws;

(C) introducing heat from an external source into the flow of liquefied material during step (B) for promoting the separation of gaseous volatiles from the liquefied material; and

(D) venting separated gaseous volatiles from the interior space at a plurality of locations along the direction of travel by communicating the interior space with respective vapor escape ports, each port being sufficiently large to prevent the linear vapor velocity of vapor escaping therethrough from exceeding a value of 10-15 f/sec, preferably not to exceed about 5.5 f/sec.

### DESCRIPTION OF THE DRAWINGS

The objects and advantages will become apparent from the following detailed description of a preferred embodiment thereof in connection with the accompanying drawing in which like numerals designate like elements, and in which:

FIG. 1 depicts a prior art extruder screw arrangement viewed in a cross sectional plane perpendicular to the axes of the conveying screws.

FIG. 2 is an exploded perspective cross-sectional view through an extruder barrel of a preferred embodiment.

FIG. 3 is a top plan view of an insert of the barrel.

FIG. 4 is a side elevational view of a preferred extruder according to the invention.

FIG. 5 is a schematic side view of a portion of an extruder screw which functions to create a gap in the material being advanced.

### DETAILED DESCRIPTION OF PREFERRED EMBODIMENTS

The present invention provides methods of devolatilizing resins that are subjected to solution polymerization and which are then subjected to devolatilization to remove the solvent and low molecular weight materials, such as unreacted monomers and low molecular weight oligomers. Such resins include acrylic resins and urethane acrylate resins. The acrylic resins include epoxy functional acrylic resins, mixed functional acrylic resins, hydroxy functional acrylic resins, heat sensitive acrylic resins, and unsaturated acrylic resins. A further description of each of these resins is set forth below.

### Epoxy Functional Acrylic Resins

Solutions in suitable solvents (such as, xylene or toluene, methylisobutyl ketone or butyl acetate) of copolymers of glycidylacrylate or glycidylmethacrylate with alkyl acrylates or methacrylates (such as methylmethacrylate, isobutylmethacrylate, 2-ethylhexylacrylate, etc) and styrene or alpha-methylstyrene having GPC molecular weights (Mw) of from 2000 to 20,000 and neat resin melt viscosities (150° C.) from 10 Poise to 700 Poise,

### Mixed Functional Acrylic Resins

Solutions in suitable solvents (such as xylene, toluene, ketones, butyl acetate or mixtures thereof with alcohol solvents) of copolymers of glycidylacrylate or glycidylmethacrylate and hydroxyethylacrylate or hydroxyethylmethacrylate or hydroxybutylacrylate or methacrylate with alkyl acrylates or methacrylates (such as methylmethacrylate, isobutylmethacrylate, 2-ethylhexylacrylate, etc) and styrene or alpha-methylstyrene having GPC molecular weights (Mw) of from 2000 to 20,000 and neat resin melt viscosities (150° C.) from 10 Poise to 2000 Poise.

### Hydroxy Functional Acrylic Resins

Solutions in suitable solvents (such as xylene, toluene, ketones, butyl acetate or mixtures thereof with alcohol solvents) of copolymers of hydroxyethylacrylate or methacrylate or hydroxybutylacrylate with vinyl alkyl acrylates or methacrylates (such as methylmethacrylate, isobutylmethacrylate, 2-ethylhexylacrylate, etc) and styrene or alpha-methylstyrene having GPC molecular weights (Mw) of from 2000 to 20,000 and neat resin melt viscosities (150° C.) from 50 Poise to 2000 Poise.

### Heat Sensitive Acrylic Compositions

The above acrylic resins that may contain from about 2 to 70% of copolymerized isobornylacrylate or methacrylate, isobutylacrylate or methacrylate, or polyetheracrylates or methacrylates such as those derived from the oxyalkylation of acrylic or methacrylic acid with ethylene or propylene oxide.

### Unsaturated Acrylic Resins

Solutions in suitable solvents of the above acrylic resins wherein the hydroxyl or epoxy groups are reacted with acrylic or methacrylic acid to give resins with pendent acrylate or methacrylate unsaturation that are millable solids at ambient temperatures, which resins have GPC molecular weights (Mw) of from 2000 to 20,000 and neat resin melt viscosities (150° C.) from 5 Poise to 2000 Poise.

### Urethane (meth)acrylate Resins

Solutions in suitable solvents (such as xylene, toluene, methylisobutylketone, butylacetate, dimethylformamide or dimethylacetamide) of the reaction products of diisocyanates, isocyanate dimers or trimers; or isocyanate-terminated polyester polyols, polyether polyols or polycarbonate polyols with hydroxyethyl acrylate or methacrylate and hydroxybutylacrylate or methacrylate, to give solid resins millable at ambient temperatures, which resins have GPC molecular weights (Mw) of from 400 to 10,000 and neat resin melt viscosities (150° C.) from 5 Poise to 2000 Poise.

The urethane acrylates are solutions in xylene or toluene or methylisobutylketone or butylacetate of the reaction products of diisocyanates, isocyanate dimers or trimers; or isocyanate terminated polyesters or polyethers with hydroxyethyl(meth)acrylate or hydroxybutyl(meth)acrylate. Such resins are typically curable with ultraviolet radiation as known in the art and are sometimes referred to as UV curable resins or UV resins. These resins have GPC molecular weights (Mw) of from 500 to 10,000 and neat resin melt viscosities (150° C.) of from 20 Poise to 1200 Poise.

The molecular weight can be determined by gel permeation chromatography against a polystyrene standards having a range of molecular weights within that of the resins being analyzed. The resin melt viscosities can be determined by an ICI Cone and Plate Viscometer, such as Model #8765 with spindle #LV3.

Suitable extruder apparatuses that can be manufactured so as to perform the methods of the present invention can be obtained from Century 3+Extruder LLC, a division of Century, Inc. of Traverse City, Mich., said equipment is generally marketed as “ring extruders.”

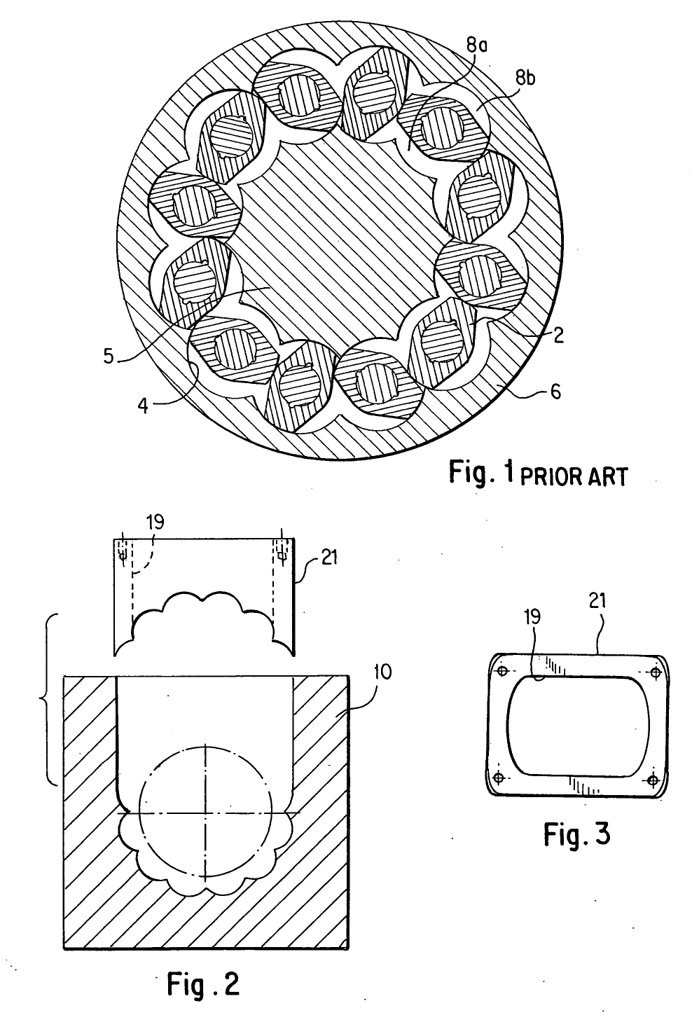

In those machines, the resin, in solution form, is devolatilized while being advanced through a space by a plurality of parallel intermeshing conveyor screws. The space can be of any suitable shape, such as the annular space shown in FIG. 1, with the screws arranged in an annular pattern therein. Accordingly, a high degree of extensional action and surface regeneration is applied to the resin solution as it is exchanged among the conveyor screws, thereby creating a very large surface area from which the solvent can escape, as well as achieving an effective degree of mixing with little foaming.

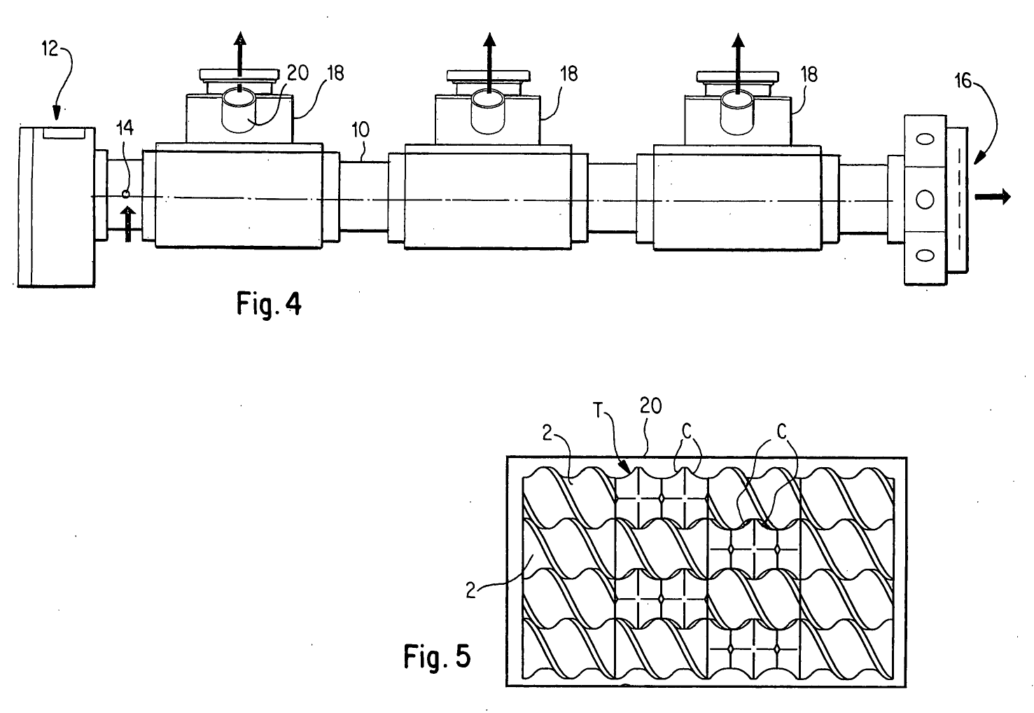

Depicted in FIGS. 2-4 is a preferred extruder embodiment which comprises a barrel 10 in which the annular conveyor screw arrangement of FIG. 1 can be incorporated. The conveyor screws are driven by a drive mechanism 12 in a conventional manner. Liquefied resin enters the barrel 10 at a single inlet 14 or at multiple inlets 14 spaced circumferentially apart and exits at a downstream outlet 16.

Spaced along the barrel in the longitudinal direction of resin feed are devolitilization (devol) towers or chambers 18 disposed atop the extruder barrel. The towers, which communicate with vapor escape ports 19 formed in removable inserts 21 of the barrel, open a significant area of the extruder body above the co-rotating screws to allow escape of the large volumes of the produced volatiles without the loss of appreciable amounts of liquefied resin. Near the top of the towers are outlets 20 through which escaping vapors are conducted above or below atmospheric pressure, as needed, to a suitable condensing and collection system.

Importantly, the system parameters are set so that the flow rate, i.e., linear vapor velocity (LVV), of the vapors escaping from the barrel does not exceed an entrainment velocity of about 10-15 feet per second (f/sec), preferably not exceeding about 5.5 f/sec. Otherwise, there is a risk that liquefied resin can be entrained by and escape along with the vapors. The primary parameters controlling this vapor escape rate are: the cross-sectional size of the vapor escape ports 19, the amount of differential pressure imposed at the tower outlets 20, the feed rate of the conveyor screws, and the temperature of the liquefied material. The feed rate, temperature and pressure differential affect the amount of volatiles being produced, and the port size and differential pressure affect the vapor escape rate. In prior extruders, the size of the escape ports was so small that the high volumes of vapor generated could not be handled. That problem could be somewhat alleviated by increasing the negative pressure, but then the vapor escape velocity would be so great that an appreciable amount of liquefied resin would escape with the vapor. It has now been discovered that by greatly increasing the size of each escape port, e.g., from one conventional size of 510 mm² to a size of 4860 mm² in one present preferred embodiment, it has become possible to control the vapor escape velocity sufficiently to minimize the loss of liquefied resin. As noted above, by limiting the vapor escape velocity so that it does not exceed about 10-15 f/sec, preferably about 5.5 f/sec, it becomes possible to prevent the escape of appreciable amounts of liquefied resin, even when very high volumes of vapors are being devolitized and removed. Linear Vapor Velocity (LVV) is calculated based on:

1) The rate of solvent S need to be removed (S=Feed rate x % of solvent). The S is further to be converted to Sn (molecular rate of solvent to be removed)=S/Molecular wt of solvent.

2) The temperature (T) and pressure (P) conditions in devolization open areas (A). Thus, the Vapor Volume Rate (VVR) through vacuum ports can be calculated as: VVR Sn×R×T/P where R is Gas Constant (or 1.315 atm-ft3/lb-moleK).

3) The LVV is calculated by: LVV=VVR/A

In one preferred embodiment, each escape port 19 was large enough to expose six of the twelve conveying screws, is evidenced from FIG. 2.

Although a ring extruder has been depicted, other screw arrangements could be utilized instead, e.g., an extruder in which the multiple screws are arranged next to one another in a straight row.

The resin solution may be preheated external to the extruder and additional heat is applied from an electrical or hot oil source built into the walls, and, optionally, into the supporting core 5 of the extruder as the resin solution is advanced, thereby further facilitating the separation of volatiles. It is usually desirable to conduct the devolatilization under reduced pressure which is applied through the outlets 20 of the devolatilization towers. In the case of resins that are relatively robust and stable in the presence of elevated temperatures, such as the acrylic resins that are not the unsaturated acrylic resins, separate shearing elements of conventional structure may be provided which subject the advancing resin solution to shear, and subject the resin to further kinetic or mechanical heating. The shearing elements may also be used to create a vacuum seal at locations between the devolatilization towers to divide the space into separate chambers (communicating with respective towers 18), permitting individual control of pressure in each tower.

In the case of resins that are relatively thermally unstable and susceptible to being damaged by shear, such as the urethane (meth)acrylate resins and unsaturated acrylic resins, heat-generating shearing is to be minimized (depending on the process temperature employed), so the provision of separate shearing elements and separately sealed venting chambers is preferably avoided. Any negative pressure produced in the conveying space would thus be generally uniform throughout the barrel. Also, the amount of externally applied heat fore and aft of the feed point(s) 14 would be carefully regulated to avoid overheating of the solution. Heating may be minimized by maximizing the vacuum to induce volatilization at as low as possible a temperature in which case shearing elements may be used to allow individual pressure control of the devolatilization towers.

When venting volatiles from thermally stable resin solutions, the solution may be at or near the boiling point when introduced into the extruder, so volatiles boil off rapidly and can be vented at atmospheric pressure at one or more of the initial venting areas; at subsequent venting areas, it may be necessary to apply a negative pressure to induce the venting. Maximum vacuum would be applied in the last devol tower to achieve very low residual volatiles in the product. By progressively increasing the application of heat as the solution flows along the passage, foaming of the solution can be minimized.

As noted earlier, in the case of thermally stable resins, it is possible to provide, within the space of the barrel along which the resin solution is advanced, vacuum seals which isolate various chambers of the space from one another, to enable pressure (e.g., vacuum levels) and temperatures to be more precisely controlled. For example, a first venting stage at a first tower could be conducted at atmospheric pressure. In a second stage at a second tower, enough vacuum is applied to maintain a high rate of distillation (but not so much that the vent passage is flooded with liquid). In the third stage at a third tower, more vacuum is applied and adjusted manually to maximize distillation to just below the flooding threshold. In a fourth stage at a fourth tower, maximum vacuum is applied e.g., 27 to 28 inches/Hg) and distillation is not so evident since most of the volatiles have been removed.

Optionally, a gaseous or liquid bleed may be introduced in this fourth stage to drop partial pressure to aid in removal of the higher boiling volatiles (O₂/N₂ mixture may be substituted in the case of UV resins to inhibit gellation).

Being able to apply different levels of vacuum at the respective towers, it is possible to use little or no vacuum, or even positive pressure, near the extruder inlet, of progressively higher vacuum toward the extruder outlet, where the volatile levels are lower. The ability to apply higher vacuum in the tower located just prior to the outlet 16 allows a finished product with the minimum levels of volatile.

Since the presence of vacuum seals produces shearing of the resin, which could adversely affect thermally unstable resins, the use of such seals, as well as any other separate shearing elements is preferably avoided when processing the thermally unstable resins (depending on the process temperature employed). In such a case, the applied vacuum would be constant across the length of the extruder barrel, and the rate of escaping volatiles would be controlled by the feed rate of the resin solution and the rotary velocity of the screws and the amount of heat applied to the resin solution.

The manner of advancing the resin through the space may tend to interfere with the venting operation. That is, since the conveying space in which the resin solution is being advanced is partitioned into radially outer and inner processing regions that are separated by the conveying screws and the resin being processed (see the radially separated regions 8a, 8b in FIG. 1) and since the venting occurs from the outer processing chamber, there is a tendency for some of the separated volatiles to become trapped in the radially inner processing region, i.e., communication between the radially inner and outer processing regions is blocked by the advancing resin solution. Thus, the amount of volatiles that are vented would be reduced. That problem is addressed by periodically forming gaps in the advancing resin solution which communicate the radially inner processing region with the radially outer processing region at the respective towers 18. Hence, separated volatiles in the radially inner processing region can escape into the radially outer region and be vented therefrom. The formation of such gaps could be accomplished mechanically by designing the conveyor screws such that in the area beneath each tower, the screw turns are machined with forward and reverse helical cuts C, see FIG. 5. The material being advanced along such turns T tend to adhere to the turns such that gaps are formed in the material to allow vapors to travel from the radially inner region to the radially outer region of the conveying space.

Another design feature that increases the devolatilization efficiency of the present invention involves the injection of a gaseous or liquid medium into the extruder body in the area of the devolatilization tower just before the product outlet 16. Injection of nitrogen, for example, at two or more circumferentially spaced points serves as a carrier to reduce partial pressure and drive out any remaining low levels of volatiles in the viscous product. Additionally, for the processing of thermally unstable resin, such as unsaturated UV curable resins described below, a gaseous stream containing some oxygen functions to bolster the inhibition system of the UV resin, besides promoting additional volatile release.

In the case of UV curable resins, and the like, it is desirable to minimize the residence time within the extruder by controlling the screw rpm. For instance, at relatively high screw velocities, and material elongation the rate of surface generation of the resin is increased, providing for more rapid devolatilization.

Since adjustments of rpm, vacuum and temperature are made according to specific resins and resin solutions during the continuous process, evaluation of the devolatilization level may be conveniently done by measuring the melt viscosity of the extrudate. In particular, since the melt viscosity of a given resin processed by batch devolatilization is known, the approximate level of volatiles is known from the melt viscosity of the resin prepared in accordance with the present invention. Typically, when equilibrium is established, much higher melt viscosities are achieved in accordance with the present invention than from batch devolatilization due to the combination of lower residual volatiles and lower oligomer (low molecular weight polymer or LMWP) content of the extrudate.

By following the teachings of the present invention, the amount of volatiles can be reduced to levels that are substantially lower than can be obtained using conventional batch processing. For instance, near zero residual volatiles and the amount of material having a weight average molecular weight below 600 can be reduced by at least 20%, preferably at least about 40% and most preferably at least about 60%. For instance, the devolatilized resin can preferably contain less than 4% by weight, more preferably less than 3% by weight and still more preferably less than 2.5% by weight of material having a weight average molecular weight below 600 as determined by gel permeation chromatography. This advantageous result can be attained without the use of separate additives that are used to inhibit depolymerization.

### EXAMPLE

Described below are the results of one test performed in accordance with the invention to devolatilize a resin that heretofore has been devolatilized by batch devolatilization. The 12-screw (30 mm screw diameter) ring extruder was provided with three successive chambers, each fitted with a vapor-escape tower. The resin syrup processed is a solution of a commercially manufactured copolymer of MMA (34%) nBMA (22.5%), Styrene (15%) and GMA (28.5%) obtained by polymerizing in xylene at 139.5 C using 5% t-butylperoxyoctoate for a total of 7 hours. Non volatile content of the syrup was 57-58%.

The syrup was preheated to 125-130° C. (i.e., below refluxing temperature) in a reservoir near the extruder. The conveyor screws were started dry and brought slowly up to 350 rpm. The syrup was pumped from the reservoir into the end of the extruder at 100 lbs/hour. Vacuum was turned on and slowly applied to each of three devol towers while observing the devol action in each of the devol chambers. At 500 rpm, vacuum was increased (slowly to avoid entrainment of resin with the exiting solvent vapor) until a distillation equilibrium was reached in each of the chambers. Small samples of extrudate were checked for melt viscosity while adjusting vacuum in each devol tower to maximize devolatilization at a constant resin solution feed rate.

At 500 rpm, a resin feed rate of 100 lbs/hr and at a vacuum of 137 mm/Hg (24.5 in/Hg), 111 mm/Hg (25.5 in/Hg), and 99 mm/Hg (26.0 in/Hg) in respective first, second and third devol towers a large sample was collected and allowed to cool.

Subsequent analysis of the product sample 329-55-3 against a sample (#6273-300) of the same resin processed in the commercial plant by batch devolatilization, conducted at a vacuum of from 1 atm (at start of devolatilization) to 10 mm/Hg (at end of devolatilization), is as follows:

| | GPC Mol. Wt data | | | | | | Residual volatiles (ppm) | | | | | |
|---|---|---|---|---|---|---|---|---|---|---|---|---|
| | MV | Tg | EEQ | Mw | Mn | % <700 | MMA | styrene | nBMA | GMA | xylene | Total |
| 6273300 (control) | 221 | 46.4 | 527 | 6697 | 3267 | 3.5 | 638 | 61 | 683 | 1299 | 795 | 3477 |
| 329-55-3 | 290 | 51.6 | 533 | 6713 | 3395 | 2.6 | 0 | 0 | 0 | 38 | 129 | 167 |

where:

GPC=(gel permeation chromatography)

MV=melt viscosity (150 degrees C., ICI Cone & Plate Viscometer)

Tg=glass transition temperature (deg. C., midpoint)

EEQ=epoxy equivalent weight

Mw=weight average molecular weight

Mn=number average molecular weight

GMA=glycidylmethacrylate

n-BMA=n-butylmethacrylate

MMA=methylmethacrylate

From the above it is apparent that resins with lower residual volatiles can be obtained by the present invention. Particularly notable is the reduced level of GMA monomer which is identified by the manufacturer as a skin sensitizer. Also, the increased Tg can be a significant advantage for the physical stability of powder coatings made from the resin i.e. the tendency of the powder to agglomerate during shipping or storage in hot weather conditions is reduced.

What is claimed is:

1. In a method of continuously devolatilizing a liquefied material, utilizing an extruder comprising a barrel defining an interior space in which is disposed a plurality of intermeshing conveying screws for advancing a flow of the liquefied material within the interior space from an extruder inlet to an extruder outlet, the method comprising the steps of:
A. providing, as the liquefied material to be devolatilized, a mixture of resin selected from the group consisting of acrylic resins and urethane (meth)acrylate resins and a solvent for the resin;
B. continuously advancing the flow of material from the extruder inlet to the extruder outlet by the conveying screws;
C. introducing heat from an external source into the flow of liquefied material during step B for promoting the separation of gaseous volatiles from the liquefied material; and
D. venting separated gaseous volatiles from the interior space at a plurality of venting locations along the direction of travel by communicating the interior space with respective vapor escape ports, each port is being sufficiently large to prevent the linear vapor velocity of vapor escaping therethrough from exceeding about 10-15 f/sec.

2. The method according to claim 1 wherein the number of screws exceeds six, and each vapor escape port has an extent in a direction transversely of the direction of flow advancement to expose at least six of the screws.

3. The method according to claim 1 wherein the screws are arranged next to one another to form a row.

4. The method according to claim 3 wherein there are twelve screws forming a circular row.

5. The method according to claim 1 wherein there are twelve of the screws arranged in a circular ring pattern.

6. The method according to claim 1 wherein a cross-sectional area of each vapor escape port exceeds 4000 mm².

7. The method according to claim 1 wherein each vapor escape port is formed in a barrel of the extruder and is communicates with a tower extending transversely outwardly from the barrel.

8. The method according to claim 1 further including during step D the step of applying a vacuum to at least a plurality of said outlet ports.

9. The method according to claim 8 wherein the liquefied material of step A is a mixture of resin consisting of acrylic resins and a solvent therefor, the interior space being divided into a plurality of separate chambers, wherein the outlet ports communicate with respective chambers.

10. The method according to claim 9 wherein the strength of the vacuum varies from one gas outlet port to the next and becomes greater toward the extruder outlet.

11. The method according to claim 10 wherein the maximum vacuum strength is in the downstream-most vapor escape port.

12. The method according to claim 9 wherein the liquefied material is a mixture of resin consisting of acrylic resin and a solvent therefore, the material being preheated to about its boiling temperature at 1 atmosphere prior to being introduced into the extruder.

13. The method according to claim 10 wherein the temperature gradient within the barrel becomes greater in a downstream direction.

14. The method according to claim 8 wherein the liquefied material of step A is a mixture of resin consisting of (meth)acrylate resins and a solvent therefor, the applied vacuum being substantially constant from one vapor escape port to the next.

15. The method according to claim 1 further including the step of mechanically forming a gap in the liquefied material in at least some of the venting locations to communicate a radially interior region of the space with a radially exterior region thereof.

16. The method according to claim 1 wherein the linear vapor velocity of vapor escape in step D does not exceed about 5.5 f/sec.

17. The method according to claim 1 wherein the material contains 10 to 60 percent volatiles.

18. The resin obtained by the method of claim 1 wherein the resin contains less than 4% by weight of material having a weight average molecular weight below 600.

19. The resin obtained by the method of claim 1 wherein the resin contains less than 3% by weight of material having a weight average molecular weight below 600.

20. The resin obtained by the method of claim 1 wherein the resin contains less than 2.5% by weight of material having a weight average molecular weight below 600.

21. In a method of continuously devolatilizing a liquefied material utilizing an extruder comprising a barrel defining an interior space in which is disposed more than six intermeshing conveying screws for advancing a flow of the liquefied material within the interior space from an extruder inlet to an extruder outlet, the interior space divided into a plurality of chambers along the direction of flow advancement, the method comprising the steps of:
A. heating a mixture of an acrylic resin and a solvent for the resin to about its boiling temperature at 1 atmosphere so as to provide the liquefied material to be devolatilized, the material containing 10-60 percent volatiles;
B. continuously advancing the flow of material from the extruder inlet to the extruder outlet by the conveying screws;
C. introducing heat from an external source into the flow of liquefied material during step B for promoting the separation of gaseous volatiles from the liquefied material;
D. venting separated gaseous volatiles from the interior space at a plurality of locations along the direction of travel by communicating the interior space with respective vapor escape ports, each vapor escape port being sufficiently large to prevent the linear vapor velocity of vapor escaping therethrough from exceeding about 10-15 f/sec; and
E. applying a vacuum to at least a plurality of the vapor escape ports during step D, wherein the strength of the vacuum varies from one chamber to the next and becomes greater toward the extruder outlet.

22. In the method according to claim 21 wherein the linear vapor velocity of step D does not exceed about 5.5 f/sec.

23. The resin obtained by the method of claim 21 wherein the resin contains less than 4% by weight of material having a weight average molecular weight below 600.

24. In a method of continuously devolatilizing a liquefied material utilizing an extruder comprising a barrel defining an interior space in which is disposed more than six intermeshing conveying screws for advancing a flow of the liquefied material within the interior space from an extruder inlet to an extruder outlet, the method comprising the steps of:
A. providing, as the liquefied material to be devolatilized, a mixture of resin consisting of urethane acrylate (methacrylate) resins and a solvent for the resin, the material containing 10-60 percent volatiles;
B. continuously advancing the flow of material from the extruder inlet to the extruder outlet by the conveying screws;
C. introducing heat from an external source into the flow of liquefied material during step B for promoting the separation of gaseous volatiles from the liquefied material;
D. venting separated gaseous volatiles from the interior space at a plurality of locations along the direction of travel by communicating the interior space with respective vapor escape ports, each vapor escape port being sufficiently large to prevent the linear vapor velocity of vapor escaping therethrough from exceeding about 10-15 f/sec.; and
E. applying a vacuum to at least a plurality of the vapor escape ports during step D, wherein the strength of the vacuum is substantially the same at each of the vapor escape ports.

25. In the method according to claim 24 wherein the linear vapor velocity of step D does not exceed about 5.5 f/sec.

26. The resin obtained by the method of claim 24 wherein the resin contains less than 4% by weight of material having a weight average molecular weight below 600.
